(19) United States
(12) Patent Application Publication
(10) Pub. No.: US 2026/0312103 A1
(43) Pub. Date: Oct. 8, 2026

(54) METHOD FOR OPERATING AN ANODE SUBSYSTEM, AND ANODE SUBSYSTEM

(71) Applicant: Robert Bosch GmbH, Stuttgart (DE)

(72) Inventors: Timo Bosch, Renningen (DE); Tobias Falkenau, Esslingen (DE)

(21) Appl. No.: 19/481,684

(22) PCT Filed: May 2, 2024
(86) PCT No.: PCT/EP2024/062090

§ 371 Date: Nov. 5, 2025

(30) Foreign Application Priority Data
May 16, 2023 (DE) 10 2023 204 565.6

(51) Int. Cl. H01M 8/0662

(52) U.S. Cl. CPC H01M 8/0662

(57) ABSTRACT

The invention relates to a method for operating an anode subsystem (1) for supplying a fuel cell stack (2) with hydrogen as anode gas, wherein anode gas exiting the fuel cell stack (2) is recirculated via an anode circuit (3) having an integrated blower (4). According to the invention, the recirculating gas, preferably before entering the blower (4), is actively conditioned, in particular, temperature-controlled, in that liquid water contained in the recirculating gas is separated, and then, with the aid of a water mist generator (5), for example an ultrasonic nebulizer, dispersed in the recirculating gas and subsequently evaporated.

The invention also relates to an anode subsystem (1) that is suitable for carrying out the method and operable according to the method.

### BACKGROUND

The invention relates to a method for operating an anode subsystem for supplying a fuel cell stack with hydrogen as anode gas. The invention also relates to an anode subsystem for supplying a fuel cell stack with hydrogen, which is suitable for carrying out the method and may be operated according to the method.

The preferred area of application is mobile fuel cell systems, in particular, fuel cell vehicles.

Hydrogen-based fuel cell systems are considered to be the mobility concept of the future, because they only emit water as exhaust gas and enable fast fueling times.

The fuel cells of a hydrogen-based fuel cell system require hydrogen and oxygen as reaction gases. These are converted into electrical energy, heat, and water in the fuel cells. The hydrogen required is stored and carried in a tank or tank system. Ambient air is generally used as the oxygen supplier.

In practice, a large number of fuel cells are stacked and combined to form a fuel cell stack. This has an anode to be supplied with hydrogen and a cathode to be supplied with oxygen. The respective reaction gas is supplied via partial systems or subsystems.

The subsystem on the anode side or anode subsystem generally comprises a tank for storing hydrogen, a shut-off valve, a hydrogen metering valve, and a jet pump. The jet pump may be used to passively recirculate anode gas exiting the fuel cell stack via an anode circuit. A hydrogen mass flow provided via the hydrogen metering valve and directed through the jet pump is used to convey the recirculated gas mass flow in the anode circuit. Alternatively or additionally, active recirculation may be achieved with the aid of a blower integrated into the anode circuit.

Recirculated anode gas becomes enriched over time with water produced in the electrochemical reaction in the fuel cells. As the recirculating gas should contain as little liquid water as possible, liquid water is separated using a water separator and collected in a tank. The tank may be emptied by opening a valve located on the tank, the so-called “drain valve.” Depending on the operating point of the fuel cell system and the separation performance of the water separator, not all liquid water may be separated, such that the recirculating gas still contains liquid water. Furthermore, water vapor contained in the recirculating gas may condense due to waste heat losses, such that further liquid water is generated.

### SUMMARY

The present invention addresses the problem of optimizing water management in an anode subsystem. In particular, the amount of liquid water contained in the recirculating gas is to be reduced and/or the liquid water is to be made available for use.

To solve this problem, the method according to the disclosure is proposed. In addition, the anode subsystem is specified according to the disclosure.

A method is proposed for operating an anode subsystem for supplying a fuel cell stack with hydrogen as anode gas. In this method, anode gas exiting from the fuel cell stack is recirculated via an anode circuit with an integrated blower. According to the invention, the recirculating gas, preferably before entering the blower, is actively conditioned, in particular, temperature-controlled, in that liquid water contained in the recirculating gas is separated, then dispersed in the recirculating gas with the aid of a water mist generator, for example, an ultrasonic nebulizer, and then vaporized.

In the dispersion step, the previously separated liquid water is fed back into the recirculating gas in the form of very fine droplets. The resulting increase in the surface area of the liquid water promotes heat absorption and thus the evaporation of the liquid water.

The evaporation of liquid water contained in the recirculating gas reduces the amount of liquid water. At the same time, the recirculating gas is conditioned, in particular temperature-controlled, as the evaporation process removes heat from the recirculating gas (“evaporative cooling”). If the liquid water is evaporated before the recirculating gas enters the blower, or while it is in the blower, the blower may be cooled at the same time using the temperature-controlled or cooled recirculating gas.

The electric motor-driven blower generates waste heat during operation. This must be removed to prevent the blower and its electronics from overheating. The blower is therefore generally actively cooled via an external cooling system. Since in the proposed method the blower is cooled with the aid of the temperature-controlled recirculating gas, the cooling capacity of the connected external cooling system may be reduced.

In a further development of the invention, it is proposed that the waste heat from the blower is used to vaporize the dispersed liquid water. This means that the evaporation process takes place in the blower. The latent heat absorption during evaporation of the dispersed liquid water then cools the blower.

The cooling of the blower by means of evaporative cooling may be set in such a way that active cooling by an external cooling system is not necessary. This also eliminates the need for a media connection for the cooling medium of the external cooling system. Since the media connection is subject to strict statutory requirements with respect to insulation resistance, the elimination of the media connection may significantly reduce the effort required to cool the blower. In addition, the anode subsystem may be installed in a vehicle independently of an external cooling system.

A water separator integrated into the anode circuit upstream of the blower is preferably used to separate liquid water contained in the recirculating gas. Since a water separator is generally already present in the anode circuit, it may be used to carry out the proposed method, such that no additional water separator is required.

Furthermore, the separated liquid water is preferably collected in a container, preferably in a container of the water separator. This ensures that the water mist generator always has a sufficient amount of liquid water available. The water mist generator is preferably integrated into the container for collecting the separated liquid water, such that installation space and costs are saved, for example, costs for additional water lines.

The amount of dispersed and vaporized liquid water may be varied depending on the operating point. Preferably, depending on the operating point, 0 to 0.5 g/s of liquid water-based on approximately 500 W blower power/100 kW stack net power-is dispersed and evaporated in the recirculating gas. This quantity is sufficient to cool a blower for a fuel cell system with a net output of up to 130 kW, for example.

Furthermore, it is proposed that the moisture content of the recirculate is also controlled via the temperature control of the recirculate. The conditioning of the recirculating gas therefore includes temperature-conditioning and humidification. Humidification of the recirculating gas may also be used to influence the relative anode humidity, which is a parameter that determines the performance and service life of a fuel cell system.

Furthermore, the temperature of the recirculating gas at the outlet of the blower is preferably used as a control variable when determining the quantity of liquid water to be dispersed and evaporated. In this way, the temperature at the outlet of the blower may be kept constant, such that overheating of the blower is safely avoided.

Alternatively or additionally, the load point of the blower and the temperature of the recirculating gas at the inlet of the blower may be taken into account when determining the quantity of liquid water to be dispersed and evaporated. Overheating of the blower is also safely avoided in this case.

In addition, an anode subsystem for supplying a fuel cell stack with hydrogen as anode gas is proposed. The anode subsystem comprises an anode circuit and a blower integrated into the anode circuit for recirculating anode gas exiting from the fuel cell stack. According to the invention, a water mist generator, for example, an ultrasonic nebulizer, is integrated into the anode circuit, preferably upstream of the blower.

The proposed anode subsystem is particularly suitable for carrying out the method according to the invention described above, or may be operated according to the method. This means that the advantages of the method according to the invention may also be achieved with the proposed anode subsystem. In particular, liquid water contained in the recirculating gas may be reduced, and cooling of the recirculating gas and the blower may be achieved by evaporating the liquid water contained.

Preferably, a water separator is integrated into the anode circuit, preferably upstream of the blower, to separate liquid water contained in the recirculating gas. Furthermore, the water separator preferably comprises a container for collecting the separated liquid water. Advantageously, the water mist generator is integrated into the tank, saving installation space and costs, for example, the cost of an additional water pipe.

Furthermore, it is proposed that at least one temperature sensor is integrated into the anode circuit to detect the temperature of the recirculating gas at the inlet and/or outlet of the blower. The amount of liquid water to be dispersed may then be determined or controlled depending on the temperature detected at the inlet and/or outlet of the blower. In the case of controlling, for example, the temperature at the outlet may be used as a control variable.

### BRIEF DESCRIPTION OF THE DRAWINGS

A preferred embodiment of the invention is described in more detail below with reference to the accompanying drawing. It shows a schematic representation of an anode subsystem for supplying a fuel cell stack with hydrogen.

### DETAILED DESCRIPTION

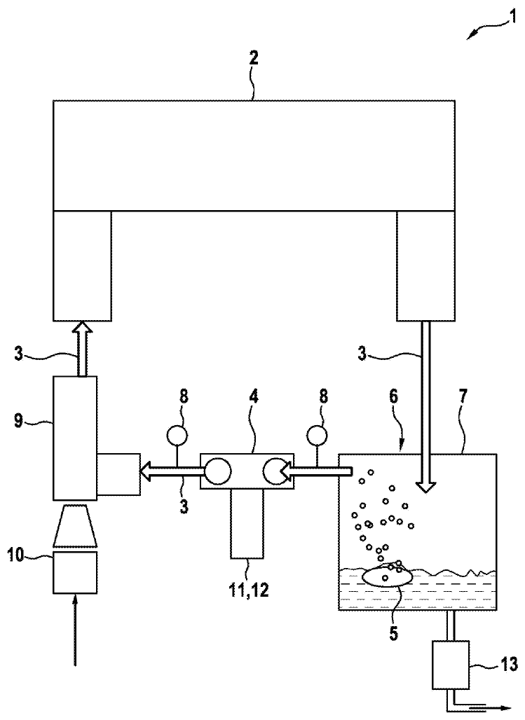

The anode subsystem 1 shown in FIG. 1 for supplying a fuel cell stack 2 with hydrogen as anode gas comprises an anode circuit 3 via which the anode gas exiting the fuel cell stack 2 is recirculated. Recirculation is achieved actively with the aid of a blower 4 integrated in the anode circuit 3 and passively with the aid of a jet pump 9. A hydrogen metering valve 10 is connected upstream of the jet pump 9, with which hydrogen is metered from a tank (not shown) into the anode circuit 3. The metered quantity of hydrogen drives the jet pump 9. The blower 4 for active recirculation has an electric motor 11 as a drive. The electric motor 11 is integrated together with power electronics 12 in a common housing.

A water separator 6 is integrated into the anode circuit 3 upstream of the blower 4. The water separator 6 is used to separate the liquid water contained in the recirculating gas. The separated liquid water is collected in a container 7 of the water separator 6. If the container 7 is full, the container 7 may be emptied by opening a valve 13, for example, a drain or purge/drain valve.

A water mist generator 5 is integrated into the container 7. The water mist generator 5 is used to disperse the separated liquid water collected in the tank 7, such that it is present in the recirculating gas in the form of very fine water droplets. The dispersed liquid water is then vaporized in the blower 4 with the aid of the waste heat generated during operation of the blower 4. The evaporation process extracts heat from the recirculating gas, such that it and the blower 4 are cooled (evaporative cooling).

By evaporating 0.1 g/s of liquid water, a cooling of the recirculating gas of 9 K may already be achieved. Depending on the amount of liquid water that is dispersed and evaporated, the necessary cooling of the blower may therefore be achieved using evaporative cooling alone. This means that a connection to an external cooling system may be omitted, which simplifies the anode subsystem 1. In particular, installation space and costs may be saved. Furthermore, the anode subsystem 1 may be integrated into a vehicle independently of an external cooling system.

To control the amount of liquid water that is dispersed and vaporized, the temperature of the recirculating gas at the outlet of blower 4 may be used as a control variable. The temperature may be recorded using a temperature sensor 8. Alternatively or additionally, the temperature at the inlet of the blower 4 may be used, such that a temperature sensor 8 may also be arranged here.

### LIST OF REFERENCE NUMBERS

1 Anode subsystem
2 Fuel cell stack
3 Anode circuit
4 Blower
5 Water mist generator
6 Water separator
7 Container
8 Temperature sensor
9 Jet pump
10 Hydrogen metering valve
11 Electric motor
12 Power electronics
13 Valve

1. A method for operating an anode subsystem (1) for supplying a fuel cell stack (2) with hydrogen as anode gas, in which anode gas exiting the fuel cell stack (2) is recirculated via an anode circuit (3) with an integrated blower (4),
wherein the recirculated gas is actively conditioned, wherein liquid water contained in the recirculated gas is separated, then dispersed in the recirculated gas with the aid of a water mist generator (5), and then evaporated.

2. The method according to claim 1,
wherein waste heat from the blower (4) is used to evaporate the dispersed liquid water.

3. The method according to claim 1,
wherein a water separator (6) integrated into the anode circuit (3) upstream of the blower (4) is used to separate liquid water contained in the recirculated gas.

4. The method according to claim 1,
wherein the separated liquid water is collected in a container (7).

5. The method according to claim 1,
wherein depending on an operating point, 0 to 0.5 g/s based on approx. 500 W blower power/100 kW stack net power, liquid water is dispersed and evaporated in the recirculated gas.

6. The method according to claim 1,
wherein a moisture content of the recirculated gas is also controlled.

7. The method according to claim 1,
wherein a temperature of the recirculated gas at an outlet of the blower (4) is used as a controlled variable in determining a quantity of liquid water to be dispersed and evaporated.

8. The method according to claim 1,
wherein a load point of the blower (4) and a temperature of the recirculated gas at an inlet of the blower (4) are taken into account when determining a quantity of liquid water to be dispersed and evaporated.

9. An anode subsystem (1) for supplying a fuel cell stack (2) with hydrogen as anode gas, comprising an anode circuit (3) and a blower (4) integrated in the anode circuit (3) for recirculating anode gas exiting the fuel cell stack (2),
wherein a water mist generator (5) is integrated into the anode circuit (3).

10. The anode subsystem (1) according to claim 9,
wherein a water separator (6) for separating liquid water contained in the recirculating gas is integrated into the anode circuit (3).

11. The anode subsystem (1) according to claim 9,
wherein at least one temperature sensor (8) is integrated into the anode circuit (3) for detecting a temperature of the recirculating gas at an inlet and/or outlet of the blower (4).

12. The method according to claim 1, wherein the recirculated gas is actively conditioned before entering the blower (4).

13. The method according to claim 1, wherein the recirculated gas is temperature-controlled.

14. The method according to claim 1, wherein the water mist generator (5) is an ultrasonic nebulizer.

15. The method according to claim 4, wherein the separated liquid water is collected in a container (7) of a water separator (6).

16. The anode subsystem (1) according to claim 9, wherein the water mist generator (5) is an ultrasonic nebulizer.

17. The anode subsystem (1) according to claim 9, wherein the water mist generator (5) is integrated into the anode circuit (3) upstream of the blower (4).

18. The anode subsystem (1) according to claim 9, wherein the water separator (6) for separating liquid water contained in the recirculating gas is integrated into the anode circuit (3) upstream of the blower

19. The anode subsystem (1) according to claim 9, wherein the water separator (6) comprises a container (7) for collecting the separated liquid water.

20. The anode subsystem (1) according to claim 9, wherein the water mist generator (5) is integrated into the container (7).
